(19) United States
(12) Patent Application Publication
(10) Pub. No.: US 2018/0083375 A1
(43) Pub. Date: Mar. 22, 2018

(54) JUNCTION BOX ASSEMBLIES FOR MULTI-VOLTAGE CONNECTION

(71) Applicant: Sumitomo Wiring Systems, Ltd., Yokkaichi (JP)

(72) Inventors: Akihiro Maximilian Matsumura, Farmington Hills, MI (US); Justin Michael Dalrymple-Kelly, Brighton, MI (US); Charles Paul Depp, Ann Arbor, MI (US); Aaron Mark Steffka, Livonia, MI (US)

(21) Appl. No.: 15/270,067

(22) Filed: Sep. 20, 2016

(51) Int. Cl. H01R 9/24; H01R 25/16; H02G 3/08; H01R 11/12

(52) U.S. Cl. CPC H01R 9/2416; H01R 25/162; H01R 11/12; H02G 3/086; H02G 3/081; H02G 3/088

(57) ABSTRACT

A power distribution box assembly with a plurality of separating walls to separate different power sources and from each other is provided. The power distribution box assembly includes a plurality of eyelet posts and busbars for powering a plurality of electric devices. First separating walls are configured to separate each eyelet post from each other. Each of the first separating walls is taller than the eyelet posts. A pair of second separating walls spaced apart from each other and open to a slit define a busbar housing. The busbar housing is configured to receive a portion of one of the busbars so as to separate the busbars from each other. Accordingly, the eyelet terminal housing is dimensioned so as to prevent a tool from contacting two eyelet posts or busbars at the same time.

### TECHNICAL FIELD

The present specification generally relates to power distribution box assemblies and, more particularly, power distribution box assemblies with an eyelet terminal housing configured to separate different power sources from each other.

### BACKGROUND

In general, power distribution box assemblies include eyelet posts. Eyelet terminals are coupled to the eyelet ports. The eyelet terminals provide an electric connection to power electric devices. The eyelet terminals are configured to link the electric devices to a power source. For instance, the power distribution box assemblies may be used in an automotive vehicle to distribute power to windshield wipers, fans for the HVAC system, mirrors or the like.

In some instances, the power distribution box includes at least two different power sources for powering different electric devices. For example, it may be desirable to have one power source be 12 volts while another power source is 48 volts. Such a configuration may be desirable in automotive vehicles configured to power electric devices having different load demands. For instance, the 12 volt power source may be used to power conventional electric devices such as windshield wipers, fans or the like and 48 volt power source may be used to power an electric motor configured to drive the automotive vehicle. The power sources are coupled to the electric devices vis-à-vis an eyelet terminal and a busbar.

Due to packaging consideration, it is often desirable have the eyelet terminals for the different power sources adjacent to each other. However, such a configuration exposes the two different power sources to a situation where the power sources may become electrically connected. For example, a tool, such as a screw driver, accidentally dropped onto one of the eyelet posts may also contact another eyelet posts, electrically connecting the two different power sources and potentially damaging the electric devices. Further, the screw driver may place into electrical contact, a busbar coupled to one power source with a busbar coupled to a different power source, electrically connecting the different power sources and potentially damaging the electric devices.

Accordingly, it remains desirable to have power distribution box assemblies having two different power sources configured to prevent the eyelet terminals and busbars from crossing each other so as to keep the power sources separate and prevent damage to electric devices from unintended acts.

### SUMMARY

In one embodiment, a power distribution box assembly with a plurality of separating walls to separate different power sources and from each other each other is provided. The power distribution box assembly houses electric components and is further configured to distribute power to a plurality of electric devices. The power distribution box assembly may include a top cover and a bottom cover. The power distribution box further includes an eyelet terminal housing having a plurality of eyelet posts configured to receive a respective eyelet terminal. The eyelet terminal housing includes a plurality of first separating walls. The first separating walls are configured to separate each eyelet posts from each other. Each of the first separating walls is taller than the eyelet terminals.

The eyelet terminal housing further includes a slit and a pair of second separating walls. The second separating walls are spaced apart from each other and open to the slit so as to define a busbar housing. The busbar housing is configured to receive a portion of a busbar so as to position the portion of the busbar underneath an under surface of a floor of the eyelet terminal housing. Accordingly, the first separating walls are dimensioned so as to prevent a tool from contacting two eyelet posts at one time. Further, the second separating walls are configured to prevent a tool from contacting two busbars at the same time. Damage to electric devices from unintended acts resulting from the crossing of two different power sources by an elongated conductive tool is achieved by physically separating the eyelet posts and busbars from each other.

In one embodiment of the power distribution box assembly, the power distribution box includes a pair of first eyelet posts configured to receive a first power source and a pair of second eyelet posts configured to receive a second power source. The first power source and the second power source are different from each other. The first pair of eyelet posts may be interleaved with the second pair of eyelet posts. The first separating walls separate each of the first and second pair of eyelet posts from each other.

In one embodiment, the power distribution box further includes a bottom housing. The bottom housing includes a plurality of connector heads configured to receive and seat a plurality of electric components. The electric components may be configured to control the actuation of electronic devices. For example, the electric components may include relays, fuses and switches.

In one embodiment of the power distribution box assembly, the eyelet terminal housing is disposed on the bottom cover of the power distribution box, wherein the first separating walls are spaced apart from each other so as to form a plurality of side openings. The side openings are open to the environment.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a power distribution box assembly according to one or more embodiments shown and described herein;

FIG. 2 is a perspective view of the power distribution box showing the connector heads;

FIG. 3 is an isolated view showing the eyelet terminals and eyelet posts, the first busbar and the second busbar;

FIG. 4 is an isolated partial view of the first busbar;

FIG. 5 is an isolated view of the second busbar;

FIG. 6 is a perspective view of the bottom cover;

FIG. 7 is a cross-sectional view of the bottom cover taken along lines 7-7;

FIG. 8 is a perspective view of the bottom cover taken from beneath the bottom cover; and

FIG. 9 is a partial cross-sectional view of FIG. 6 taken along lines 9-9.

### DETAILED DESCRIPTION

Reference will now be made in detail to embodiments of a power distribution box assembly with a plurality of separating walls to separate different power sources and from each other. The power distribution box assembly includes a plurality of eyelet posts and busbars for powering a plurality of electric devices.

First separating walls are configured to separate each eyelet post from each other. Each of the first separating walls is taller than the eyelet posts. A pair of second separating walls spaced apart from each other and open to a slit define a busbar housing. The busbar housing is configured to receive a portion of one of the busbars so as to separate the busbars from each other. Accordingly, the first separating walls are dimensioned so as to prevent a tool from contacting two eyelet posts at one time. Further, the second separating walls are configured to prevent a tool from contacting two busbars at the same time. Damage to electric devices from unintended acts resulting from the crossing of two different power sources by an elongated conductive tool is achieved by physically separating the eyelet posts and busbars from each other.

Directional terms as used herein—for example “up”, “down”, “right”, “left”, “front”, “back”, “top”, “bottom”—are made only with reference to the figures as drawn and are not intended to imply absolute orientation.

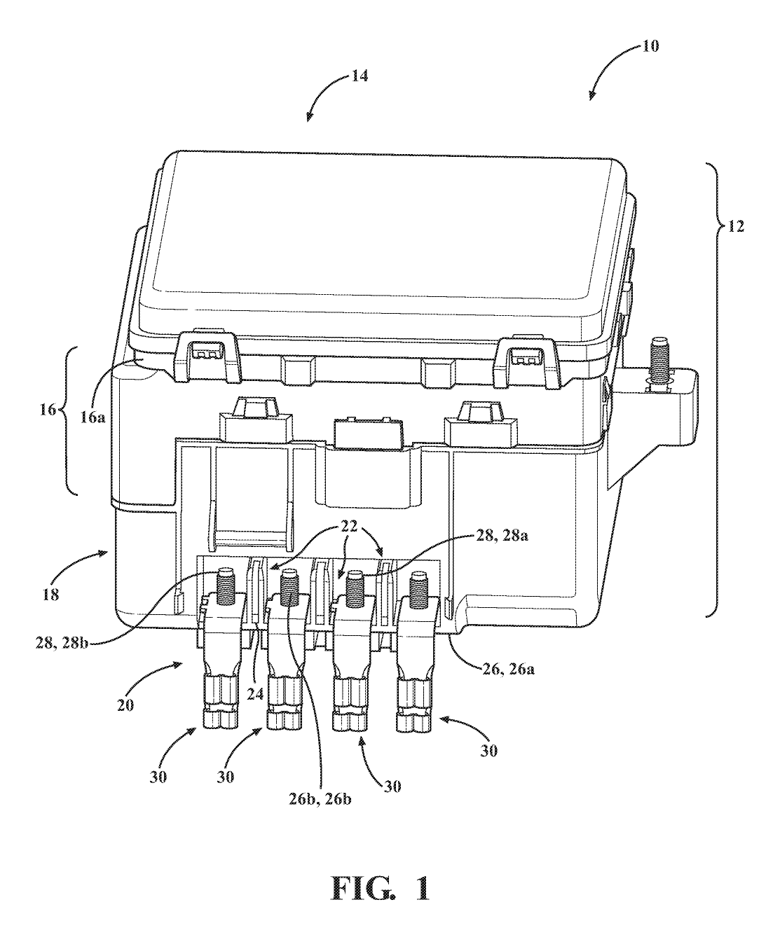

With reference now to FIG. 1 an illustrative embodiment of a power distribution box assembly 10 is provided. The power distribution box assembly 10 may be formed of a non-conductive material suitable for injection molding such as polypropylene. The power distribution box assembly 10 includes a power distribution box 12 configured to house electric components (not shown). The power distribution box 12 is illustratively shown having a top cover 14, a bottom housing 16 and a bottom cover 18. The top cover 14 is mounted onto a top portion 16a of the bottom housing 16. The top portion 16a is illustratively shown as a separate piece but may be integrally formed with the bottom housing 16. The bottom cover 18 is mounted to the bottom of the bottom housing 16, so as to place the bottom housing 16 between the top cover 14 and the bottom cover 18.

FIG. 1 shows an embodiment of the power distribution box assembly 10 wherein the eyelet terminal housing 20 is disposed on the outer edge of the bottom cover 18. The eyelet terminal housing 20 includes a plurality of first separating walls 22 extending upwardly from a floor 24 of the bottom cover 18. A pair of first eyelet posts 26 and a pair of second eyelet posts 28 are disposed within eyelet terminal housing 20. The first separating walls 22 are taller than each of the eyelet posts 26, 28.

The pair of first eyelet posts 26 include a first input terminal 26a and a first output terminal 26b. The pair of second eyelet posts 28 include a second input terminal 28a and a second output terminal 28b. Eyelet terminals 30 are coupled to a respective first and second eyelet posts 26, 28. It should be appreciated that the eyelet terminal housing 20 may be located elsewhere without deviating from the scope of the appended claims.

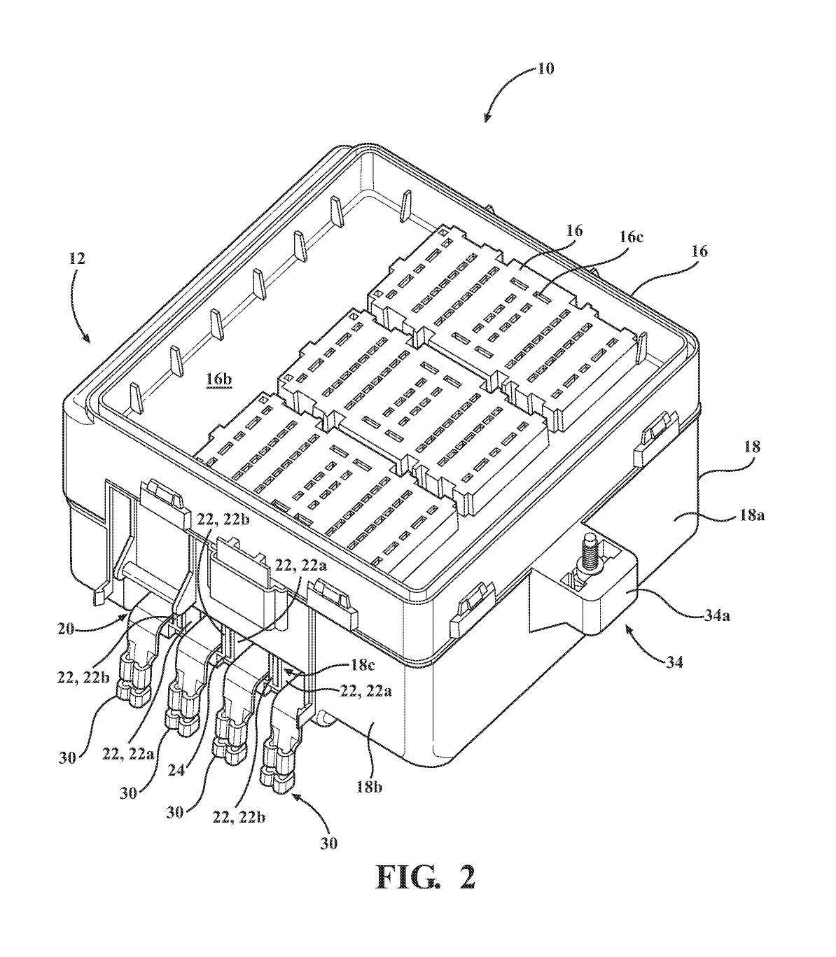

FIG. 2 is a perspective view of the power distribution box assembly 10 with the top cover 14 removed. FIG. 2 provides a top down view of the bottom housing 16. The bottom housing 16 includes a substrate 16b. Integrally formed on the substrate 16b are the connector heads 16c. The connector heads 16c have a plurality of openings 16d for which a terminal connector (not shown) may pass through to complete an electric connection. The connector heads 16c may be configured to receive various electric components for controlling electric devices, such as switches, relays, controllers and the like (not shown). The design of the power distribution box 12 is not limiting and may be based upon the number of electric components necessary to control an electric system, or a plurality of electric devices.

The power distribution box 12 is shown as having a generally rectangular box shaped dimension. The bottom housing 16 is mounted to the top portion 16a by a snap-fit engagement, and the bottom housing 16 and the top portion 16a are mounted to the bottom cover 18 by a plurality of fasteners having a male part fixedly disposed on an outer wall of the bottom cover 18 and a complimentary female part disposed on an outer wall of the bottom housing 16. Likewise, the bottom housing 16 is mounted to the top cover 14 by a plurality of fasteners having a male part fixedly disposed on an outer wall of the top cover 14 and a complimentary female part disposed on an outer wall of the bottom housing 16. It should be appreciated that the fasteners shown herein are illustrative and not limiting, and any fastener currently known or used in the art may be adapted for use herein.

The bottom housing 16 may include a jump terminal 34. The jump terminal 34 may include a support member 34a integrally formed on a side wall 18a of the bottom cover 18. The bottom cover 18 includes a front wall 18b having an opening 18c. The eyelet terminal housing 20 is disposed behind the opening 18c of the front wall 18b so as to be disposed within the bottom cover 18. The opening 18c provides access to the eyelet terminal housing 20. For illustrative purposes, the eyelet terminal housing 20 is shown housing a pair of first eyelet posts 26 configured to receive a first power source and a pair of second eyelet posts 28 configured to receive a second power source.

FIG. 2 also provides an illustration of the first separating walls 22. The first separating walls 22 are disposed between each of the eyelet posts 26, 28 so as to separate the eyelet posts 26, 28 from each other. Each of the first separating walls 22 is shown illustratively formed by a first wall 22a and a second wall 22b spaced apart from the first wall 22a.

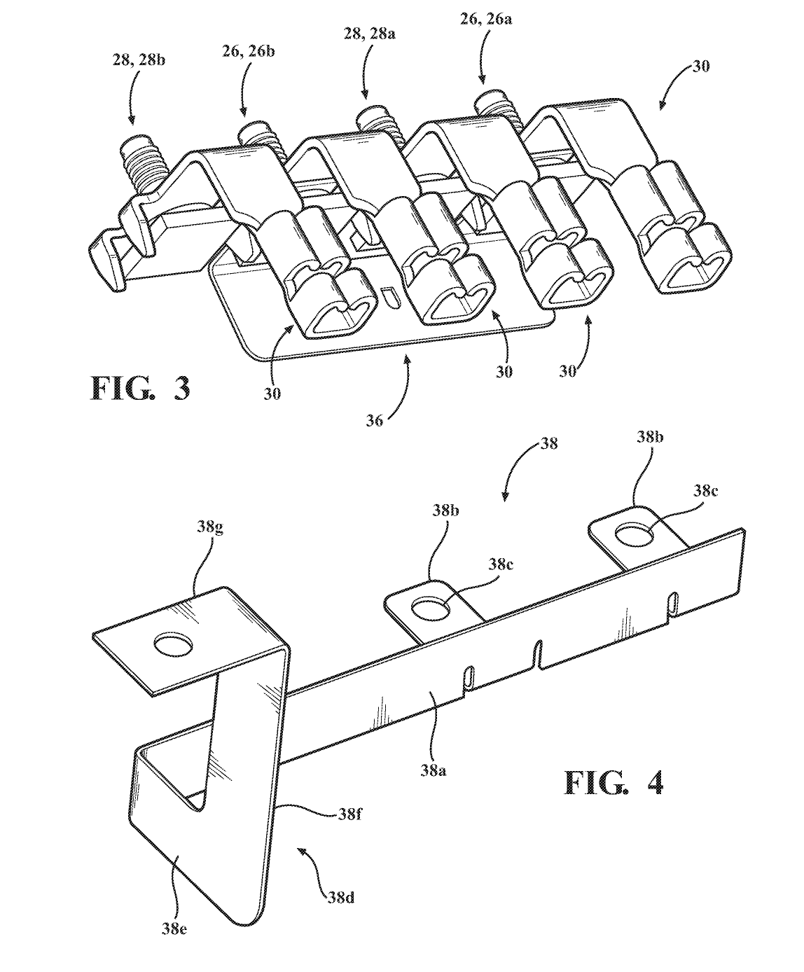

FIG. 3 is an isolated view showing the pair of first eyelet posts 26 and the pair of second eyelet posts 28. The eyelet posts 26, 28 are illustratively shown as a threaded bolt extending rigidly in an upright manner from a planar base 32. The pair of first eyelet posts 26 may include a first input terminal 26a and a first output terminal 26b, and the pair of second eyelet posts 28 may include a second input terminal 28a and a second output terminal 28b.

A first busbar 36 electrically connects the first input terminal 26a to the first output terminal 26b. A second busbar 38 electrically connects the second input terminal 28a to the second output terminal 28b (as seen in FIG. 7). Thus is should be appreciated that having multiple eyelet posts 26, 28 allows multiple devices to be attached to a respective power source. For instance, an electric device may be powered by a 12 volt power source by connection to either the first input terminal 26a or the first output terminal 26b Likewise, an electric motor may be powered by a 48 volt power source by connection to either the second input terminal 28a or the second output terminal 28b.

FIG. 4 is an isolated view of the second busbar 38. The second busbar 38 is formed of a conductive material configured to conduct electric power to the second eyelet posts. The second busbar 38 is a generally planar member. The second busbar 38 includes a second member 38a having a pair of second attachment arms 38b. Each second attachment arm 38b includes an aperture 38c for receiving a respective second input and second output terminal 28a, 28b. The second busbar 38 further includes a jump connection 38d. The jump connection 38d is shaped to connect to the jump terminal 34. Thus, the jump connection 38d may provide power from an auxiliary power source to the second eyelet posts 28. For illustrative purposes, the jump connection 38d is shown as having a first connecting portion 38e disposed on proximal end of the second member 38a. A second connecting portion 38f extends upwardly from a proximal end of the first connecting portion 38e and a third connecting portion 38g is disposed on a distal end of the second connection portion 38f and is generally orthogonal to the second connecting portion 38f.

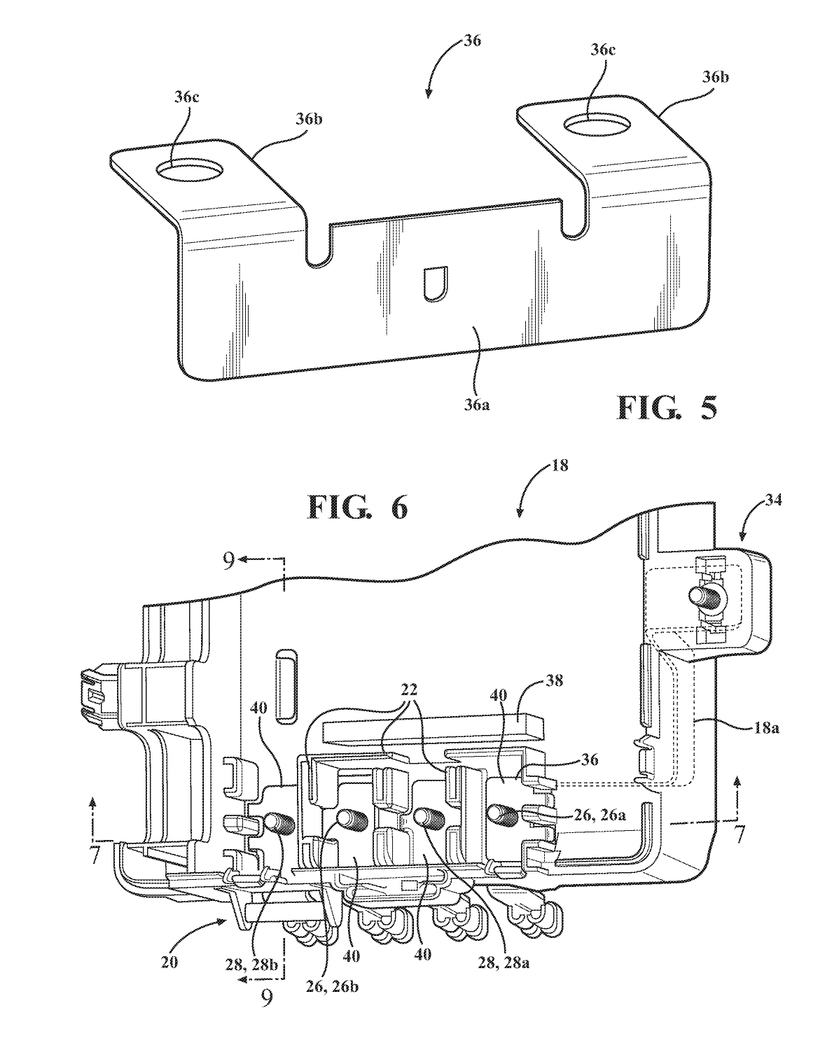

With reference now to FIG. 5, an isolated view of the first busbar 36 is provided. The first busbar 36 is formed of a conductive material configured to conduct electric power to the first eyelet posts 26. The first busbar 36 is a generally planar member. The first busbar 36 is illustratively shown as having a first planar member 36a and a pair of first attachment arms 36b disposed on opposite ends of the first planar member 36a. Each of the first attachment arms 36b includes an aperture 36c for receiving respective first eyelet posts. The first planar member 36a is generally orthogonal to the first attachment arms 36b.

FIG. 6 provides a top down view of the bottom cover 18 showing the eyelet terminal housing 20. The power distribution box assembly includes three first separating walls 22 which form four housing units 40 for housing each of the first and second eyelet posts 26, 28. The first and second eyelet posts 26, 28 are interleaved with each other, wherein the second output terminal 28b, the first output terminal 26b, the second input terminal 28a and the first input terminal 26a are sequentially arranged in a side-by-side relationship.

FIG. 7 is a cross-sectional view of FIG. 6 taken along lines 7-7. FIG. 7 illustrates how the first separating walls 22 are taller than the first and second eyelet posts 26, 28. FIG. 7 also shows the first and second busbars 36, 38 connected with respective first and second eyelet posts 26, 28. FIG. 7 also illustrates how the second busbar 38 connects the second eyelet posts 28 to the jump terminal 34. The first attachment arms 36b are coupled to respective first eyelet posts 26. The first planar member 36a is hidden behind a second separating wall 40. In particular, the first planar member 36a is disposed beneath the first connection portion 38e of the second busbar 38 so as to prevent a conductive tool dropped within the eyelet terminal housing 20 from creating an electric connection between the first and second busbars 36, 38.

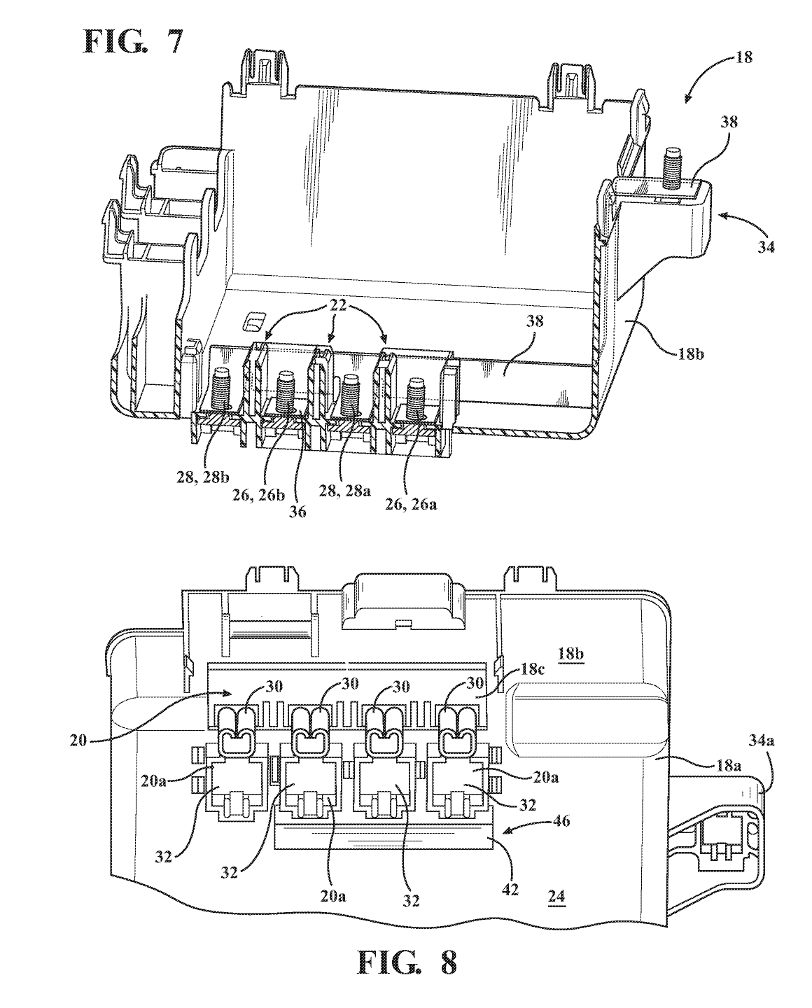

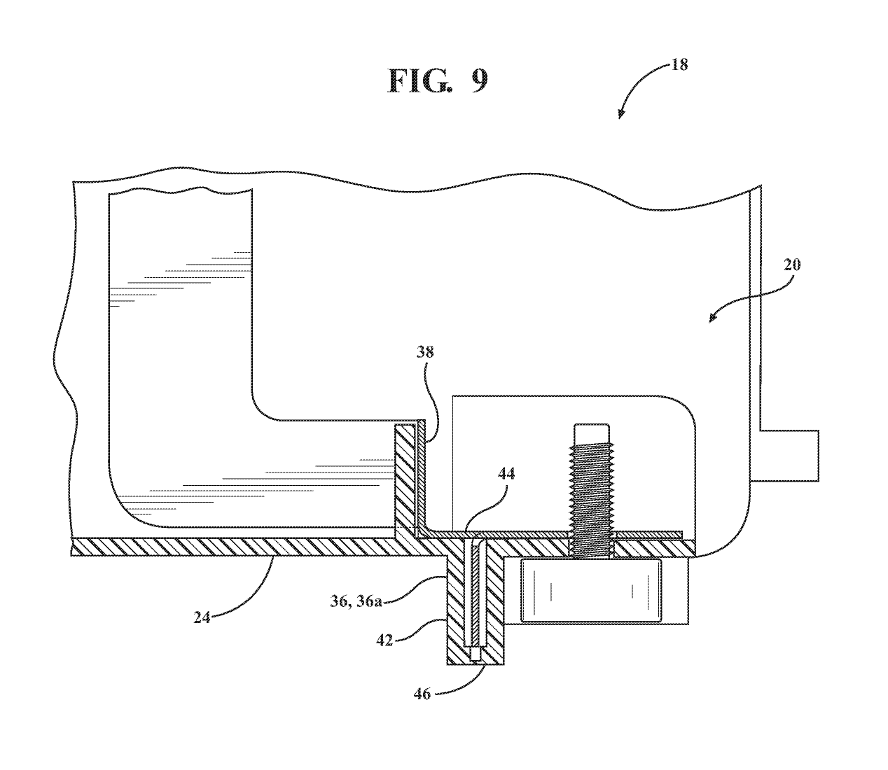

FIGS. 8 and 9 illustrate how the second separating wall 42 isolates the first busbar 36 from the second busbar 38. FIG. 8 is a view taken of the underside of the bottom cover 18, showing the second separating walls 42 and the busbar housing 46. The eyelet terminal housing 20 may include four openings 20a disposed on the floor 24 of the bottom cover 18. Each planar base 32 of a respective eyelet post 26, 28 is disposed within a respective opening 20a. Eyelet terminals 30 are mounted to a respective eyelet post 26, 28. The eyelet terminals 30 are configured to hold an electric wire (not shown).

FIG. 9 provides a cross-sectional view of FIG. 8 showing the pair of second separating walls 42. The eyelet terminals 30 from FIG. 9 have been removed for instructional purposes. The second separating walls 42 are spaced apart each other so as to form a slit 44 on a top surface of the eyelet terminal housing 20 and a busbar housing 46. A portion of the first busbar 36 is disposed within the busbar housing 46. In particular, the first planar member 36a of the first busbar 36 is disposed within the busbar housing 46 so as to be disposed underneath the floor 24 of the bottom cover 18. FIG. 9 illustrates how the second separating wall 40 positions the first busbar 36 apart from the second busbar 38.

In operation, the power distribution box assembly 10 is delivered to the manufacturer for installation into a product. For illustrative purposes, assume the power distribution box assembly 10 is used in an automotive vehicle. The automotive vehicle includes two different power sources (not shown) having different power. One power source is coupled to the first eyelet post 28 and the other power source is coupled to the second eyelet posts 28. During assembly of the automotive vehicle, it is necessary to connect different electric devices to each power source. In the event additional work must be done after the connection is made, the first and second separating walls 22, 42 prevent an elongated conductive tool, such as a screw driver, from electrically connecting the first power source to the second power source. In particular, the second separating wall 42 places the first busbar 36 beneath the second busbar 38 so as to prevent an elongated tool from contacting both the first and second busbars 36, 38 simultaneously. Likewise, the first separating walls 22 prevent an elongated conductive tool from contacting the first input terminal 26a, first output terminal 26b, second input terminal 28a, and second output terminals 28b simultaneously.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A power distribution box assembly configured to distribute power from two different power sources, the power distribution box assembly comprising:
a power distribution box defining a storage space having a floor;
a first busbar, wherein the first busbar includes a first planar member and a pair of first attachment arms disposed within the storage space, each of the pair of first attachment arms are disposed on opposite ends of the first planar member and are generally orthogonal to the first planar member;
a second busbar having a second attachment arm; and
an eyelet terminal housing disposed within the power distribution box and housing a plurality of eyelet posts, wherein at least a portion of the first busbar, the second busbar are housed within the power distribution box, and wherein the pair of first attachment arms of the first busbar is electrically connected to a predetermined number of the plurality of eyelet posts, and the second attachment arms of the second busbar is electrically connected to a remaining number of the plurality of eyelet posts, a plurality of first separating walls disposed on a top surface of the floor separating each of the eyelet posts from each other and a pair of second separating walls disposed on an undersurface of the floor, each of the pair of second separating walls spaced apart from each other so as to form a busbar housing, wherein the first planar member is disposed within the busbar housing, a portion of the first busbar disposed within the busbar housing, and wherein the pair of second separating walls define a slit in the eyelet terminal housing, a portion of the first busbar being disposed within the slit.

2. The power distribution box assembly as set forth in claim 1, wherein each of the plurality of first separating walls is taller than each of the plurality of the eyelet posts.

3. (canceled)

4. (canceled)

5. (canceled)

6. The power distribution box assembly as set forth in claim 1, wherein the plurality of eyelet posts is a pair of first eyelet posts and a pair of second eyelet posts, wherein the pair of first eyelet posts includes a first input terminal and a first output terminal, the pair of second eyelet posts includes a second input terminal and a second output terminal, and the power distribution box includes a top cover, a bottom housing and a bottom cover.

7. (canceled)

8. (canceled)

9. (canceled)

10. The power distribution box assembly as set forth in claim 6 wherein the eyelet terminal housing is disposed on the bottom cover.

11. The power distribution box assembly as set forth in claim 10, wherein the bottom cover includes a front wall and a pair of side walls, the front wall having an opening providing access to the eyelet terminal housing.

12. The power distribution box assembly as set forth in claim 11, wherein the busbar housing is disposed beneath the eyelet terminal housing.

13. The power distribution box assembly as set forth in claim 6, wherein the pair of first eyelet posts is interleaved with the pair of second eyelet posts.

14. The power distribution box assembly as set forth in claim 13, wherein the first busbar is electrically coupled to the pair of first eyelet posts and the second busbar is electrically coupled to the pair of second eyelet posts.

15. The power distribution box assembly as set forth in claim 6, further including a jump terminal, the second busbar electrically connecting the jump terminal with the pair of second eyelet posts.
